(19) United States
(12) Patent Application Publication
(10) Pub. No.: US 2023/0045502 A1
(43) Pub. Date: Feb. 9, 2023

(54) SYSTEMS AND METHODS FOR ENHANCING SUGGESTIONS WITH AN EFFECTIVENESS INDEX

(71) Applicant: AKTANA, INC., San Francisco, CA (US)

(72) Inventors: Gil BLUSTEIN, San Francisco, CA (US); Pinchas BEN-OR, San Francisco, CA (US); Amy BAER, San Francisco, CA (US)

(21) Appl. No.: 17/819,029

(22) Filed: Aug. 11, 2022

Related U.S. Application Data
(63) Continuation of application No. PCT/US21/19469, filed on Feb. 24, 2021.
(60) Provisional application No. 62/981,384, filed on Feb. 25, 2020.

(51) Int. Cl. G06Q 30/02

(52) U.S. Cl. CPC G06Q 30/0281; G06Q 30/0201

(57) ABSTRACT

The present disclosure provides a method for generating an index score. The method may comprise (a) obtaining data associated with a plurality of interactions between (i) a plurality of sales representatives and (ii) a customer; (b) for each sales representative: (i) processing the data to determine a plurality of components of the index score; (ii) applying a plurality of weights and standardizations to the plurality of components to generate a plurality of metrics; (iii) aggregating the plurality of metrics to generate the index score, wherein the index score is indicative of an effectiveness of the sales representative in interacting with the customer; (c) selecting, based on the index scores of the plurality of sales representatives, a sales representative of the plurality of sales representatives; and (d) displaying, on a graphical user interface of an electronic device of the sales representative, a recommended interaction between the sales representative and the customer.

### CROSS-REFERENCE

This application is a continuation of International Patent Application PCT/US21/19469, filed on Feb. 24, 2021, which claims the benefit of U.S. Provisional Application No. 62/981,384, filed on Feb. 25, 2020, each of which is incorporated by reference herein in its entirety.

### BACKGROUND

Pharmaceutical sales representatives (reps) and marketing managers responsible for managing health care provider (HCP) communications may use different methods when promoting to doctors or other health care providers to purchase their companies' drugs and treatments. For example, marketing managers may direct reps to give HCPs promotional merchandise, invite them to speak at conferences, etc. In order to engage with HCPs, medical sales reps may communicate with them using different methods, including in-person meetings, phone calls, instant messaging, email, and mail. In order to effectively communicate with HCPs, reps may need to build relationships with the HCPs in order to establish levels of knowledge and rapport.

When pharmaceutical reps communicate with HCPs, they often rely on their own personal relationships with the HCPs and their own intuition in order to market the products and services. However, pharmaceutical reps and the market managers that manage communications with HCPs often do not have empirical methods to complement or enhance their marketing efforts, and as such their sales and marketing efforts is largely a subjective process. Data collection can be difficult, and thus effectiveness can be difficult to measure. In addition, computer-generated or standardized sales processes often lack the personal touches that enable medical reps to successfully sell products to the HCPs with whom they have relationships. Because the reps may be unable to synthesize data-driven methods with their personal relationships, and the marketing managers may not be able to leverage communications data effectively to help the reps communicate, reps may be hindered from making successful sales.

### SUMMARY

There is a need for systems and methods that can provide message suggestions to reps and marketing managers that are likely to act upon and are likely to increase engagement between reps and HCPs. An effectiveness index is disclosed herein that can be used with a decision support engine to enhance suggestions sent to reps or marketing managers. The systems and methods disclosed herein can utilize machine learning to analyze interactions between reps and HCPs, calculate various metrics, and combine the metrics to produce the effectiveness index. The effectiveness index may indicate the effectiveness of a particular rep or marketing manager in interacting with an HCP to increase the HCPs engagement and purchase of pharmaceuticals.

In one aspect, the present disclosure provides a computer-implemented method for generating an index score. The method may comprise (a) obtaining data associated with a plurality of interactions between (i) a plurality of sales representatives and (ii) a customer; (b) for each sales representative: (i) processing the data to determine a plurality of components of the index score; (ii) applying a plurality of weights and standardizations to the plurality of components to generate a plurality of metrics; (iii) aggregating the plurality of metrics to generate the index score, wherein the index score is indicative of an effectiveness of the sales representative in interacting with the customer; (c) selecting, based on the index scores of the plurality of sales representatives, a sales representative of the plurality of sales representatives; and (d) displaying, on a graphical user interface of an electronic device of the sales representative, a recommended interaction between the sales representative and the customer.

In some embodiments, the method further comprises (e) updating the index score as new data is being obtained in (a). In some embodiments, the index score is updated on a predefined time interval. In some embodiments, the method further comprises (0 displaying the index score as a graphical object in a web portal to the first group, wherein the graphical object is configured to visually change over time as the index score is being updated. In some embodiments, the plurality of interactions comprises historical and/or on-going interactions between an entity of the first group and an entity of the second group.

In some embodiments, the plurality of interactions occurs over a plurality of channels. In some embodiments, the plurality of weights are based on a channel type of each of the plurality of channels. In some embodiments, the plurality of channels comprises one or more of the following: (1) email communications; (2) mobile text messages; (3) social media websites; (4) mobile applications; (5) telephone calls; (6) in-person meetings; (7) video conferencing; (8) conferences or seminars; or (9) events conducted at facilities connected to entities from the second group. In some embodiments, the plurality of components comprises a rate or a probability of a customer opening one or more email communications sent by an entity from the first group to an entity from the second group. In some embodiments, the one or more email communications comprises at least three email communications. In some embodiments, the plurality of components comprises a tenure of interactions between an entity from the first group and an entity from the second group. In some embodiments, the tenure extends over a predefined timeframe. In some embodiments, the tenure comprises a number of completed visits by the entity from the first group and the entity from the second group within the predefined timeframe. In some embodiments, the plurality of components comprises a number of completed visits by the entity from the first group and the entity from the second group over a target time period. In some embodiments, the target time period is defined as a business or sales quarter. In some embodiments, the plurality of components comprises a cadence or frequency of visits by the entity from the first group and the entity from the second group. In some embodiments, the plurality of components comprises a probability or a rate of the entity from the first group acting on one or more suggestions to visit the entity from the second group. In some embodiments, the plurality of components comprises a probability or a rate of the entity from the first group acting on one or more suggestions to send email communications to the entity from the second group. In some embodiments, the one or more suggestions are automatically generated by a decision support engine (DSE). In some embodiments, the one or more suggestions comprises a number of DSE-generated suggestions for the entity from the first group to visit the entity from the second group. In some embodiments, the one or more suggestions comprises a number of DSE-generated suggestions for the entity from the first group to send the email communications to the entity from the second group. In some embodiments, the plurality of components comprises an achievement rate of the entity from the first group completing the one or more suggestions generated by the DSE. In some embodiments, the plurality of components comprises a utilization rate of the entity from the first group using one or more of the plurality of channels to engage with the entity from the second group. In some embodiments, the DSE is configured to use the index score to generate one or more future suggestions to the entity from the first group for engaging with the entity from the second group. In some embodiments, the one or more future suggestions are customized for each rep and the entity from the second group.

In some embodiments, the index score is useable to assist the entity from the first group in enhancing or improving engagement with the entity from the second group. In some embodiments, the index score is useable as a proxy for estimating sales in an absence of actual historical sales data. In some embodiments, the index score is useable to evaluate and modify existing assignments between reps and customers or evaluate and modify existing marketing strategies implemented by marketing managers, in order to optimize the marketing or sales of the one or more products. In some embodiments, the one or more products comprises one or more pharmaceutical products, and the customers comprise one or more healthcare providers.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows a system for algorithmically producing context-aware suggestions for pharmaceutical sales representatives or for marketing managers, in accordance with some embodiments;

FIG. 2 illustrates components of an engagement engine, in accordance with some embodiments;

FIG. 3 shows a distribution for a probability of emails opened for rep-account visit pairs, in accordance with some embodiments;

FIG. 4 shows a distribution of tenure for reps, in accordance with some embodiments;

FIG. 5 illustrates a distribution for completed visits per quarter for reps, in accordance with some embodiments;

FIG. 6 illustrates a distribution of visit cadence for reps, in accordance with some embodiments;

FIG. 7 illustrates a distribution of probabilities of following suggestions for reps to visit HCPs, in accordance with some embodiments;

FIG. 8 illustrates a distribution of probabilities of following suggestions for reps to email HCPs, in accordance with some embodiments;

FIG. 9 illustrates a distribution of achievement rates for rep-account pairs, in accordance with some embodiments;

FIG. 10 illustrates a distribution of channel utilization for all rep-account pairs, in accordance with some embodiments;

FIG. 11 illustrates a distribution of the effectiveness index, which aggregates metrics analyzed in FIGS. 3-10, in accordance with some embodiments;

FIG. 12 illustrates correlations between the effectiveness index and output for three different organizations, in accordance with some embodiments;

FIG. 13 illustrates additional correlations between the effectiveness index and output for the three different organizations, in accordance with some embodiments;

FIG. 14 illustrates a chart indicating changes in correlation of the index to output over time, in accordance with some embodiments;

FIG. 15 shows an implementation of the index score being used to predict engagement between a rep and an HCP, in accordance with some embodiments;

FIG. 16 shows an implementation of trigger suggestions, in accordance with some embodiments;

FIG. 17 illustrates methods for generating reason text to send to reps along with submission text, in accordance with some embodiments;

FIG. 18 illustrates examples of presented reason text, in accordance with some embodiments;

FIG. 19 illustrates a message flow diagram for generating an effectiveness index compiled by measuring a set of engagement metrics using machine learning, in accordance with some embodiments; and

FIG. 20 shows a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The systems and methods disclosed herein can be configured to provide relationship-aware suggestions to a decision support engine. The suggestions may be based in part on a score produced by analyzing interactions between entities of a first group and entities of a second group. In a disclosed implementation, the decision support engine provides the generated suggestions to a first group of pharmaceutical sales reps (pharma reps), whose conduct may be managed by marketing managers managing HCP communications, to initiate or enhance communications with a second group of health care providers (HCPs). The suggestions may be configured to increase engagement between the reps and HCPs, so that the reps may generate more sales and cause the HCPs to fill more prescriptions.

The decision support engine may generate suggestions using an engagement score generated using metrics produced with machine learning analysis and an index score. The engagement system may take as inputs interaction data between reps and HCPs, including messages sent by reps to HCPs, events attended by reps and HCPs, location data from reps and HCPs, and HCP reactions to rep communications. The metrics produced from these inputs from machine learning algorithms may include adherence to calendar events, location prediction, a tendency to engage with suggestions, engagement patterns with health care providers, relationships between reps and HCPs. The effectiveness of a representative or marketing manager in interacting with an HCP may be measured using an index score (also referred to as “index” or “effectiveness index” in this disclosure) the system may produce using a machine learning algorithm. To produce the index score, the metrics may be weighted and combined algorithmically or manually. For example, the index may be a weighted sum, composite, or product of two or more of the metrics. The index score may be combined with the machine learning output to produce the engagement score, which is then provided to the decision support engine.

The system may also provide reason text along with the suggestions. The reason text may provide context to the reps or marketing managers and may persuade the reps to follow the suggestions or may persuade the marketing managers to implement sales tactics incorporating the suggestions. The reason text may be algorithmically generated reason text, providing reps and marketing managers with data about how likely suggestions are to result in engagement between reps and HCPs. The reason text may also be personalized to the particular rep it is sent to.

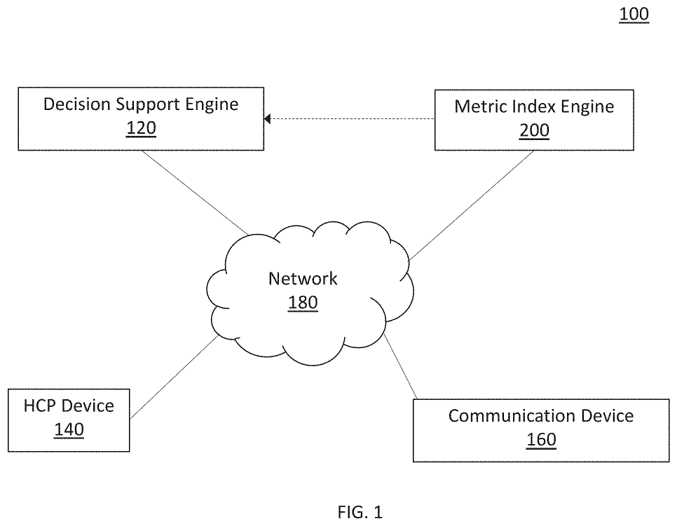

FIG. 1 illustrates a system 100 for algorithmically producing context-aware suggestions for pharmaceutical sales representatives (reps) and marketing managers. The system includes a decision support engine 120, an HCP device 140, a communication device 160, and a network 180.

The decision support engine 120 may generate for a first group of entities suggestions to use when communicating with a second group of entities. For example, the decision support engine 120 may generate pharmaceutical sales representatives (sales reps) and marketing managers suggestions to use when communicating with health care providers (HCPs). Suggestions may be words, phrases, or sentences, or combinations thereof. The decision support engine 120 may provide a sales rep or marketing manager with a ranked list of a particular number of suggestions that may be critical to act upon or to use to plan future interactions with one or more HCPs. The decision support engine 120 may generate suggestions that have been mathematically determined to improve engagement. Suggestions may be tailored or personalized to individual reps, groups of reps (e.g., reps selling particular products), particular marketing managers, or market managers overseeing particular products or strategies. The decision support engine may select particular reps or particular marketing managers to provide suggestions to. For example, the decision support engine may provide suggestions to reps with the largest index scores with particular HCPs, to ensure increased effectiveness of the suggestions to the particular HCPs.

The engagement engine 200 provides the decision support engine 120 with an engagement score to enable the decision support engine 120 to produce suggestions that may be more actionable. The engine 200 may collect interaction data between reps and HCPs and analyze the data using one or more machine learning algorithms to produce an engagement score 280. The engagement score may be based in part on an index score 260.

The HCP device 140 is a device used by the HCP to communicate with a rep. The HCP device 140 may be a computing device with network connectivity, such as a mobile device (e.g., a cellular phone or smartphone), desktop computer, laptop computer, tablet computer, or another kind of computing device. The HCP may be a doctor, surgeon, nurse practitioner, physician assistant, Doctor of Pharmacy, nurse, physical therapist, occupational therapist, or another medical practitioner.

The communication device 160 is a device used by the sales rep to communicate with an HCP or by the marketing manager to communicate strategies to a rep. The communication device 160 may also be a computing device with network connectivity, such as a mobile device (e.g., a cellular phone or smartphone), desktop computer, laptop computer, tablet computer, or another kind of computing device. The rep or marketing manager may send messages via email, short message service (SMS), voicemail, telephone conversation, Internet chat programs, bulletin board systems, social media direct messages, or via other networked or non-networked communication methods. The communication device 160 may include a software application, such as a desktop computer application or a mobile device application, to receive suggestion candidates from the decision support engine 120. The software application may be configured to operate with APPLE® MACINTOSH or iOS, MICROSOFT® WINDOWS, GOOGLE® ANDROID or CHROME OS, UNIX, or LINUX operating systems.

The network 180 connects the system 100 to other elements of its environment. The network 180 may be an Internet network 180, a LAN, a WAN, telecommunications network 180, a data network 180, or another type of network.

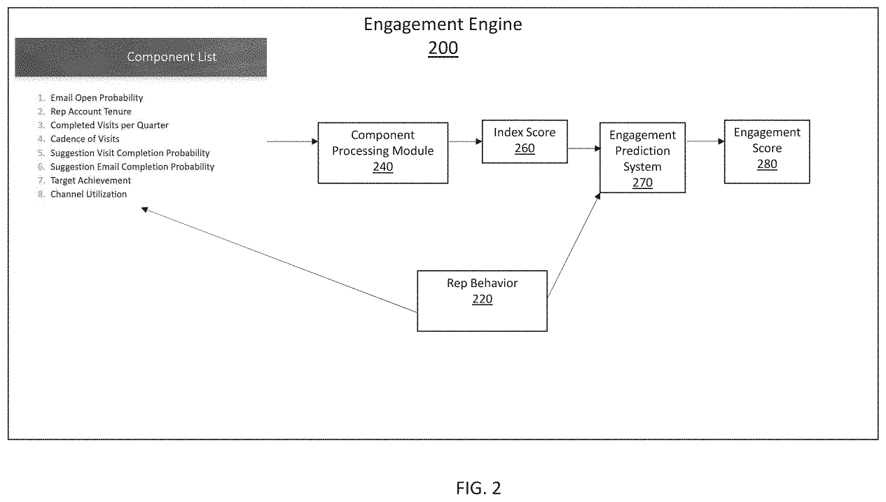

FIG. 2 illustrates components of the engagement engine 200. The engagement engine 200 may determine engagement between a first group of entities and a second group of entities. In the disclosed implementation, the first group includes reps and marketing managers and the second group includes HCPs. The engagement engine 200 includes a collected rep behavior 220, which provides data for producing the components used for the index score 260 as well as for analysis by the engagement prediction system 270. The engagement prediction system produces an engagement score 280, in part using the index score 260.

The rep behavior 220 may include interaction information between reps and HCPs. Interaction information may include messages sent by reps, actions taken (or not taken) by HCPs after receiving messages from reps, events attended by reps and/or HCPs, numbers of contact attempts from reps to HCPs, relationship information between reps and HCPs, demographic information (age, gender), professional information about HCPs (position, title, practice group, education).

Rep behavior 220 may be used to produce a component list. The component list may include components used to calculate the index 260, including email open probability, rep account tenure, completed visits per quarter, cadence of visits, suggestion visit completion probability, suggestion email completion probability, target achievement percentage, and channel utilization.

The component processing module 240 calculates the index score 260. The component processing module 240 may use a variety of weighting criteria to weight its components to produce the index score 260. These criteria may be adjusted in order to configure the index score to be more predictive of rep output. For example, the index components may be weighted equally (e.g., Index=(Component1+Component2+Component3+Component4+Component5+Component6+Component7+Component8)/(Total Number of non-NA components)). The index may be a weighted sum with different weight multipliers connected to each component (e.g., Index=(Weight1*Component1+Weight2*Component2+Weight3*Component3+Weight4*Component4+Weight5*Component5+Weight6*Component6+Weight7*Component7+Weight8*Component8)/(Total Number of non-NA components)). The weighted components may be referred to as metrics in this disclosure, and the sum of the weighted components may be referred to as an index, index score, effectiveness index, or the like. The components may all be normalized to be numbers between 0 and 1, in order to control the contributions made from the components to the index.

Some of the components, such as the email open score, the suggestion visit score, and the suggestion email score, may be expressed as probabilities. For example, the email open score may indicate a propensity for a rep to open an email, with a score close to 0 indicating a low propensity to open an email, and a score close to 1 indicating a high propensity to open an email.

Additional components may not be probabilistic and may be normalized using arithmetic operations. These scores may include the tenure score, visit score, cadence score, and target achievement score.

The index score 260 may incorporate historical interaction data and historical suggestion data to be able to provide the engagement prediction system 270, and ultimately the decision support engine 120, with information needed to generate suggestions. The index score 260 may describe the depth of a connection between a particular rep and an HCP, with a rep having an index score for each HCP he or she may interact with. Reps may be able to view their scores with the HCPs they interact with. Scores may be calculated on a daily, weekly, monthly, or yearly basis. The score may be calculated using parameters including a number of interactions on each channel with the HCP, the frequency of interactions, the durations of the interactions, and the output generated by the reps as a result of the interactions (such as sales made or prescriptions filled). If multiple reps are engaging with a particular HCP, the effectiveness index may be able to determine which reps are contributing the most to an HCP's purchase or prescription filling decisions. In this manner, the system may assess efficacies of multiple strategies implemented by marketing managers. If one set of one or more reps is implementing one strategy advised by a marketing manager, and another set of one or more reps is implementing another, the effectiveness index may determine which strategy is most effective, from its determination of which reps' actions are most effective. The score may be impacted negatively by dismissals of rep communications by HCPs.

Communication channels between the rep and HCP may contribute unequally to engagement and may be weighted differently when calculating index scores. The system may give reps who interacted more with HCPs per channel higher scores. More recent communications between reps and HCPs may contribute more to index scores than older communications. Longer interactions, rather than shorter interactions, may producer higher scores. Reps may send event invitations to HCPs, and HCPs accepting more invitations may produce higher effectiveness indices for such reps. Reps who sell more units or cause more prescription writeups may receive higher index scores. In addition, sunshine acts performed by HCPs to reps may increase index scores. Dismissal of rep suggestions by HCPs may lower index scores.

The index score 260 may be displayed as a graphical object in a web portal to the reps. As the index score 260 is updated, the graphical object may be configured to visually change over time.

The index score 260 may be used to estimate sales if historical sales data is not available. The index score's component parts may be related to or correlate with sales and may thus be predictive in determining benefits of rep behavior toward HCPs.

The engagement prediction system 270 may use machine learning algorithms to predict one or more metrics that the system may combine with the index score 260 to produce the engagement score 280. These predicted metrics may include adherence to calendar events, location prediction, a tendency to engage with suggestions, engagement patterns with health care providers, relationships between reps and HCPs. The effectiveness index may incorporate information from acted suggestions, non-acted suggestions, or both.

The engagement prediction system 270 may predict an adherence to calendar events for one or more reps. The system may, using machine learning, analyze data of past event attendance to predict whether a rep will attend one or more future meetings on the rep's calendar.

The engagement prediction system 270 may determine a planned location from the calendar event. The system may extract location information from the event, which may be a street address or latitude/longitude coordinates. From earlier locations of events, the engagement prediction system 270 may be able to predict future locations for the rep, in order to determine which HCPs may be attending events the rep may be attending or other nearby events.

The engagement prediction system 270 may also analyze the calendar event to extract items of information relating to one or more event topics. In conjunction with brand information, previous messages to HCPs, and information about other events, the engagement prediction system 270 may use the event topic information to predict one or more planned topics for future events. The engagement prediction system 270 may use natural language processing to extract one or more words or phrases from the event title or description text and assign one or more topic labels to the event topic. The system may determine future event topics using, in part, frequencies of topic labels from past events.

Location prediction may allow the system to determine the rep's location in a future period. The future period may be within the next few days, weeks, months, or years. A location prediction system may use hierarchical clustering of rep movement (using the rep's meetings) to determine a likely average latitude and longitude for the rep. Location prediction may also calculate daily maximum distances between facilities the rep may visit. The predicted location may be used to target messages or suggestions based on the rep's location and may also consider visits planned in advance.

The engagement prediction system 270 may track a rep's tendency to engage with suggestions. Engagement, in the context of this system, is achieved when a rep's actions closely track suggestions provided by the decision support engine 120. The engagement prediction system 270 may track which actions reps perform when provided with suggestions and determine whether these actions constitute engagement. The engagement prediction system 270 may use machine learning to predict whether reps accept, dismiss, or ignore messages containing suggested text from the decision support engine 120. The system will predict whether a rep is likely to follow through with a suggestion from a message.

The engagement prediction system 270 may use a multiclass classifier with a number of discrete possibilities. Possibilities may include ignoring a suggestion, sending a message including suggestion text, and acknowledging a suggestion but not acting on it. The engagement prediction system may produce a score indicating how likely it is that one of the discrete possibilities will occur.

The engagement prediction system 270 may predict engagement patterns for engagement between reps and HCPs. The engagement prediction system may predict whether a rep may engage with an HCP over a channel on a particular day if suggestions are presented. Predicting engagement patterns for engagement between reps and HCPs may also use a multiclass classifier. The classifier may produce predictions as to which channel of contacting the rep may be the most effective. Another multiclass classifier may be used to predict which times may be best for the rep to engage with the HCP.

The engagement prediction system 270 may analyze suggestion history from reps. The engagement prediction system may classify suggestions for which it has data into acted suggestions and non-acted suggestions.

Acted suggestions may be inputs into any of the machine learning analysis methods described. Acts may include acceptances and acknowledgements. Accepted suggestions are suggestions that reps have performed. The system may consider time elapsed from providing suggestions to reps to the reps acting on the suggestions. Regardless of the elapsed time, any suggestion that the rep performs may be considered to be an accepted suggestion. Frequencies with which reps accept suggestions may affect engagement outcomes for the reps. The decision support engine 120 may model engagement considering frequencies of accepted suggestions.

Non-acted suggestions include dismissed suggestions and ignored suggestions.

The system may use machine learning algorithms 240 to predict whether reps are likely to dismiss or ignore suggestions. The machine learning algorithms 240 used may enable the system to learn to better provide suggestions from analyzing dismissed and ignored suggestions.

The engagement score 280 may be produced from the machine learning output of the engagement prediction system 270 and the index score 260. The engagement score 280 may be a simple sum of these factors, a weighted sum, a product, or another mathematical combination of these factors. For example, the engagement score 280 may be expressed as engagement score=rep calendar adherence+rep location+rep engagement with suggestions+index score. In order to configure engagement levels, each of the engagement score components may be provided with a particular weight. The system may provide the weights to the metrics using manual input or algorithmically. For example, the system may assign a target engagement score and iteratively increase or decrease weights in order to produce the target score.

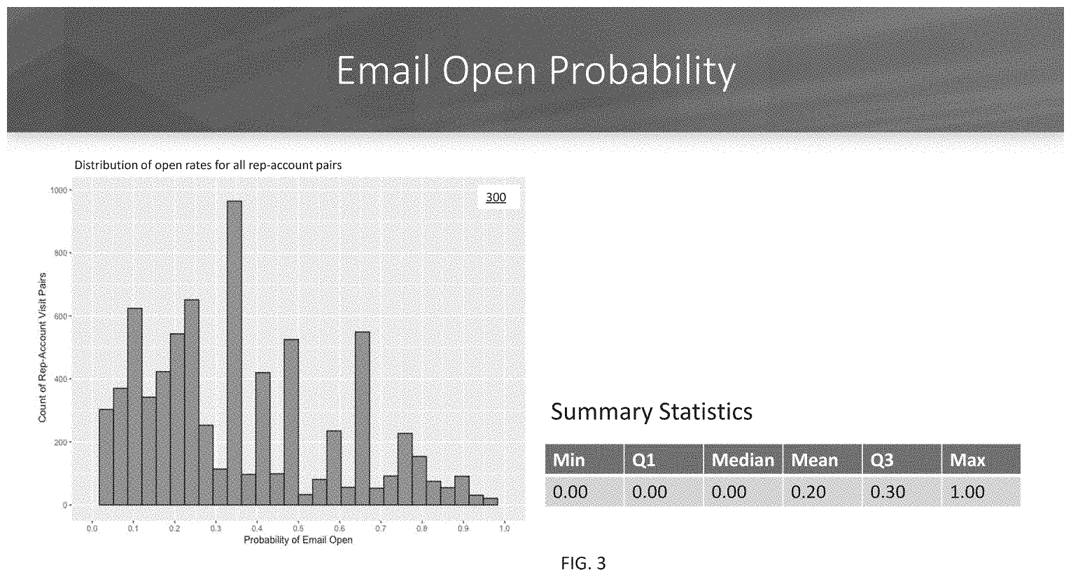

In each of FIGS. 3-15, graphs plot various metrics used to calculate the index score against counts of rep-account visit pairs. A rep-account visit pair may represent a relationship between a particular rep and a particular HCP, wherein the rep may visit the HCP to solicit pharmaceutical sales or attempt to get prescriptions filled. Many of the graphs illustrate a bell-curve distribution, although some are skewed towards lower or higher average metric values.

FIG. 3 shows a distribution 300 for a probability of emails opened for rep-account visit pairs. The chart illustrates a distribution skewed towards lower probabilities of emails being opened by HCPs, indicating a larger percentage of lower-performing reps than higher-performing reps. The chart shows data for reps that have sent at least three emails to accounts.

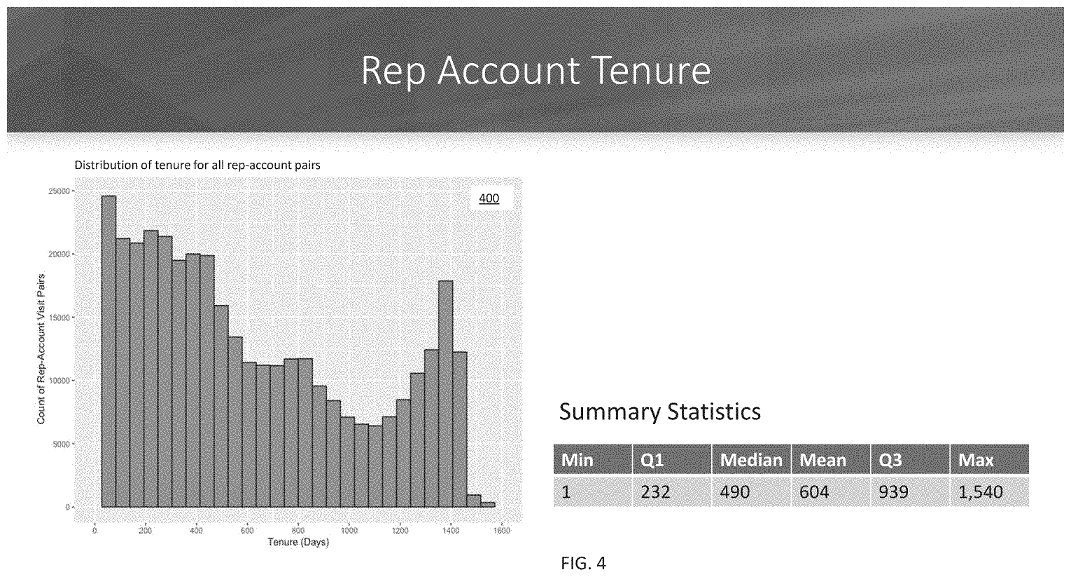

FIG. 4 shows a distribution 400 of tenure for reps. Tenure may be the length of a relationship between a rep and an HCP. The graph shows data for reps that have completed visits to particular HCPs twice within two years. The graph has two peaks, with one peak occurring at a short tenure and the other peak occurring at a long tenure.

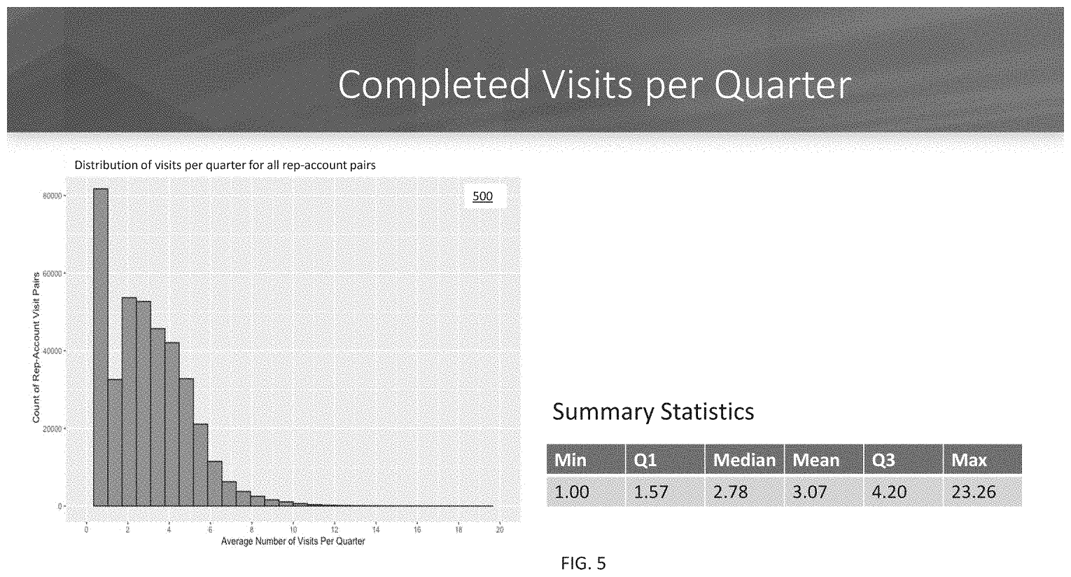

FIG. 5 illustrates a distribution 500 for completed visits per quarter for reps. The graph is skewed towards a low number of visits per rep, indicating that most reps do not visit HCPs more than three times per quarter. The distribution 500 may indicate the marginal value of increasing visits beyond four visits is low.

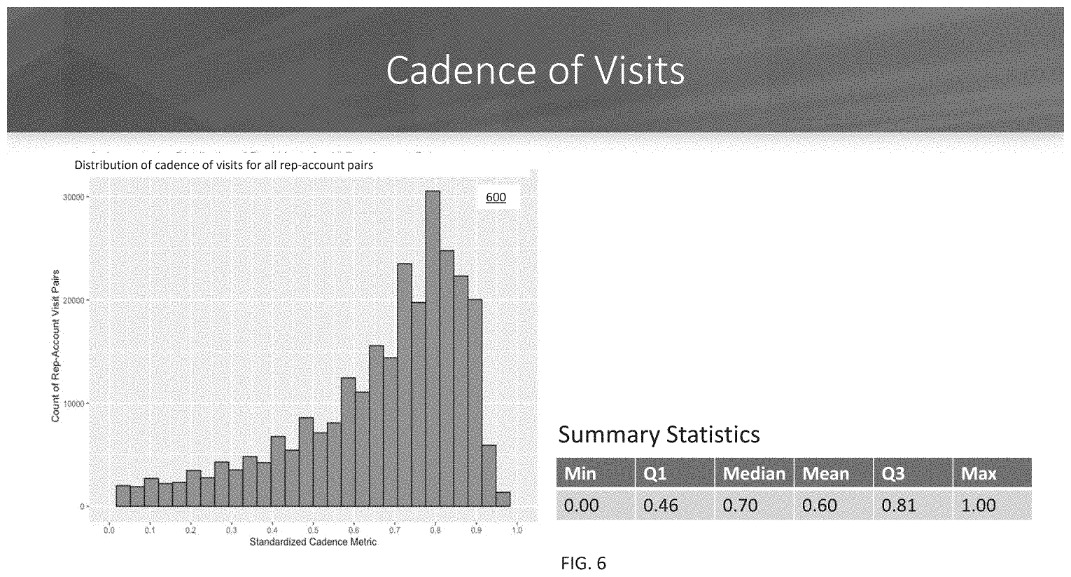

FIG. 6 illustrates a distribution 600 of visit cadence for reps. This distribution is skewed for the right, indicating a higher average standardized cadence per rep. Cadence reflects both how often reps visit accounts and how evenly spaced rep visits to HCPs are. As may be observed in the illustration 600, reps that visit accounts more frequently and regularly are common.

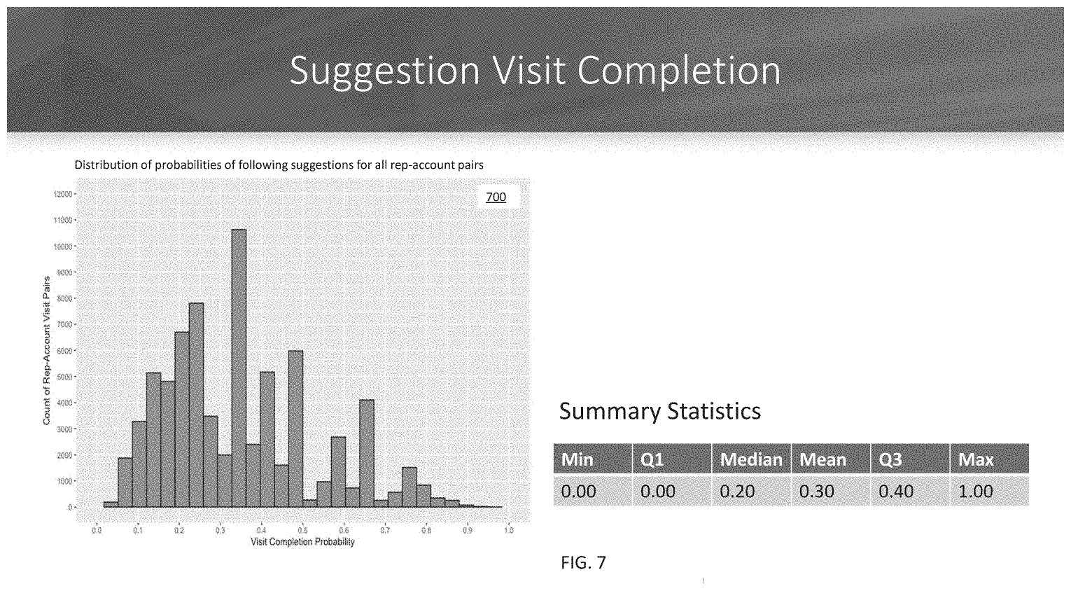

FIG. 7 illustrates a distribution 700 of probabilities of following suggestions for reps to visit HCPs. The decision support engine has provided at least three visit-related suggestions to reps included in the chart. In distribution 700, on average, a rep visits an HCP 30% of the time when provided with a suggestion.

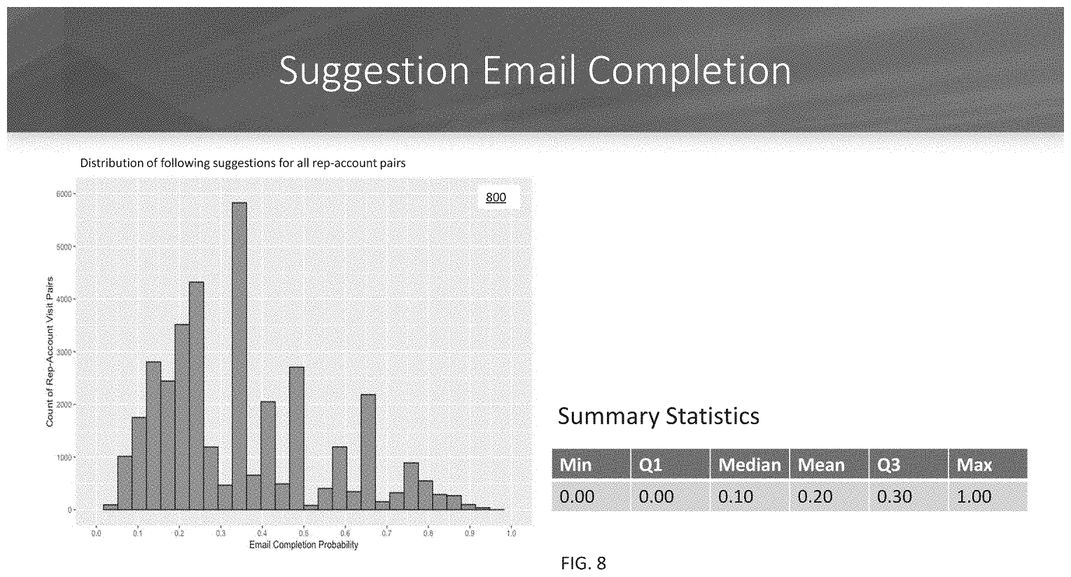

FIG. 8 illustrates a distribution 800 of probabilities of following suggestions for reps to email HCPs. The decision support engine has provided at least three email-related suggestions to reps included in the chart. In distribution 800, on average, a rep emails an HCP 20% of the time when provided with a suggestion.

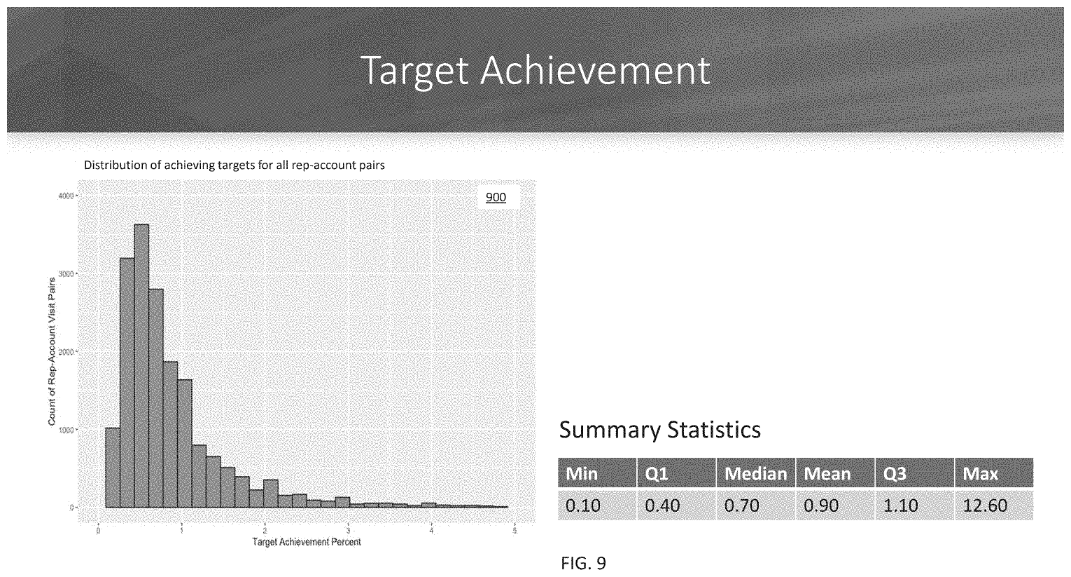

FIG. 9 illustrates a distribution 900 of achievement rates for rep-account pairs. Targets may be assigned numbers of interactions, such as visits or emails to HCPs. The target period may be a day, week, month, year, or may be a business period or sales quarter. The distribution 900 is skewed towards fewer completed interactions.

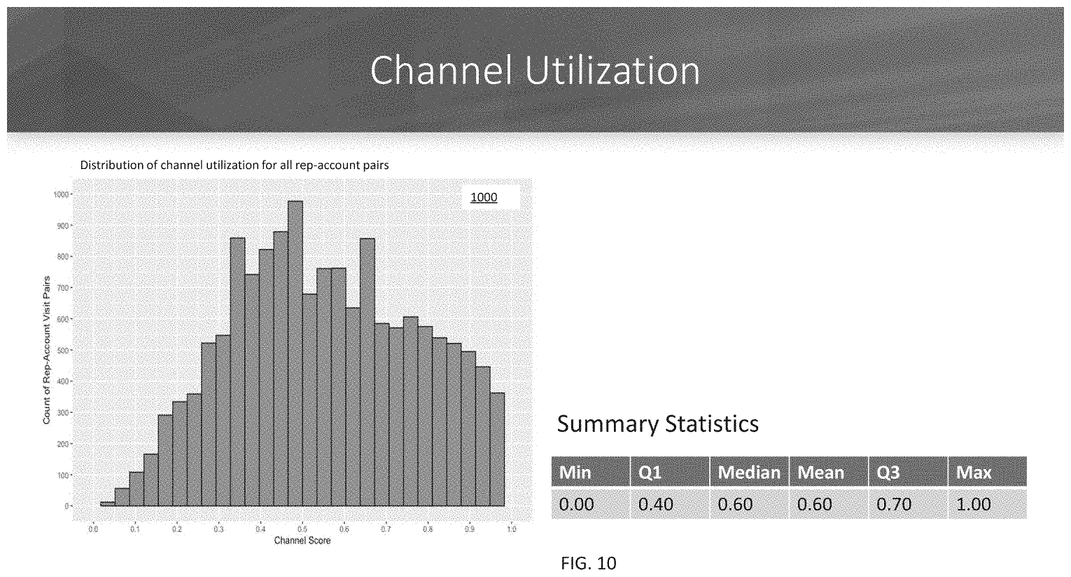

FIG. 10 illustrates a distribution 1000 of channel utilization for all rep-account pairs. The distribution measures a normalized score indicating how many channels the rep is using to contact HCPs. The distribution 1000 indicates that reps tend to use more channels of communication rather than fewer. Channels may comprise one or more of the following: (1) email communications; (2) mobile text messages; (3) social media websites; (4) mobile applications; (5) telephone calls; (6) in-person meetings; (7) video conferencing; (8) conferences or seminars; or (9) events conducted at facilities connected to entities from the second group.

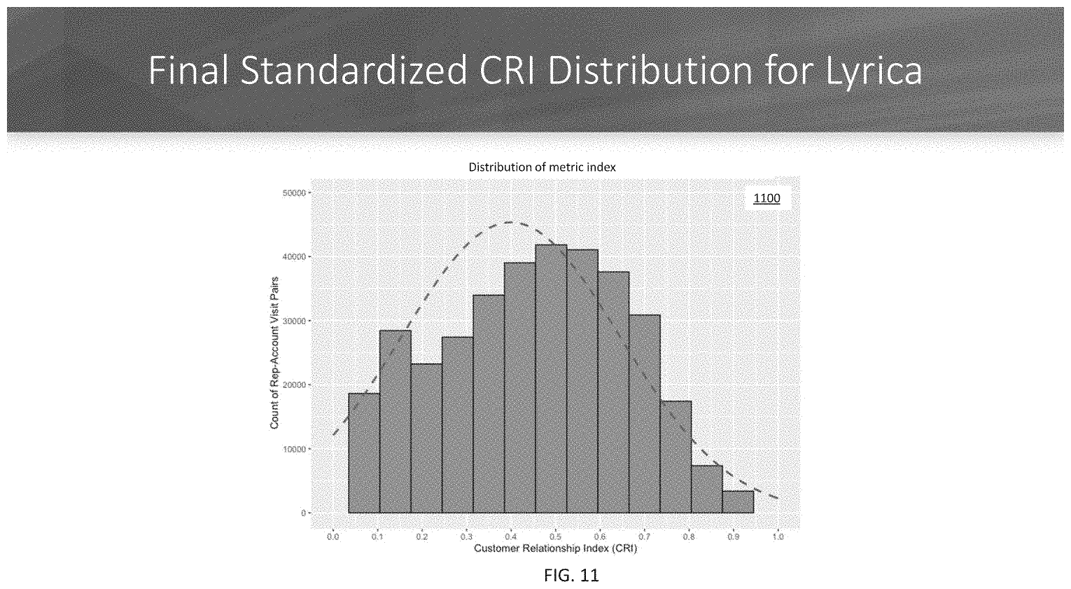

FIG. 11 illustrates a distribution 1100 of the effectiveness index, which aggregates metrics analyzed in FIGS. 3-10. The distribution 1100 approximates a normal distribution, indicating that reps tend to have indices near the median.

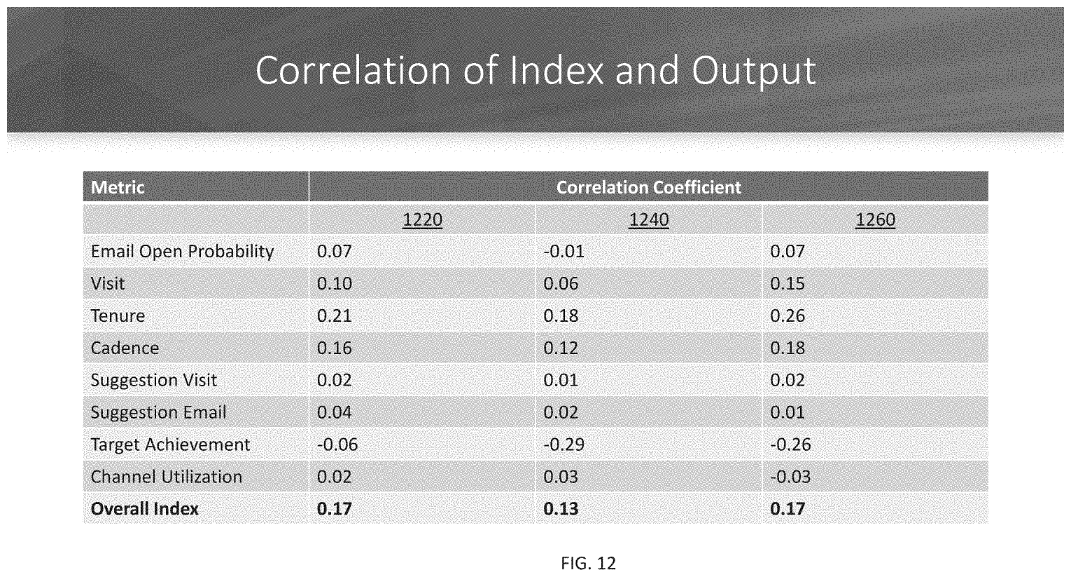

FIG. 12 illustrates correlations between the effectiveness index and output for three different organizations 1220, 1240, and 1260. FIG. 12 illustrates individual correlations for each of the components of the index to output as well as the correlation of the overall index to output. A correlation may be interpreted as a slope in a linear relationship to predict output for a particular rep.

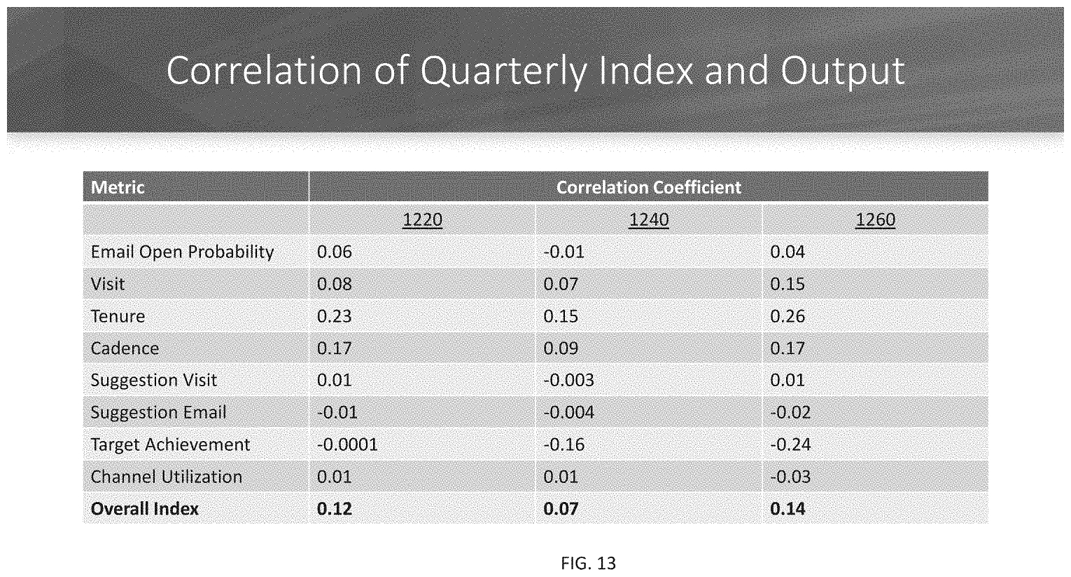

FIG. 13 illustrates additional correlations between the effectiveness index and output for the three different organizations 1220, 1240, and 1260, for a quarterly time duration. FIG. 13 illustrates individual correlations for each of the components of the index to output as well as the correlation of the overall index to output. A correlation may be interpreted as a slope in a linear relationship to predict output for a particular rep.

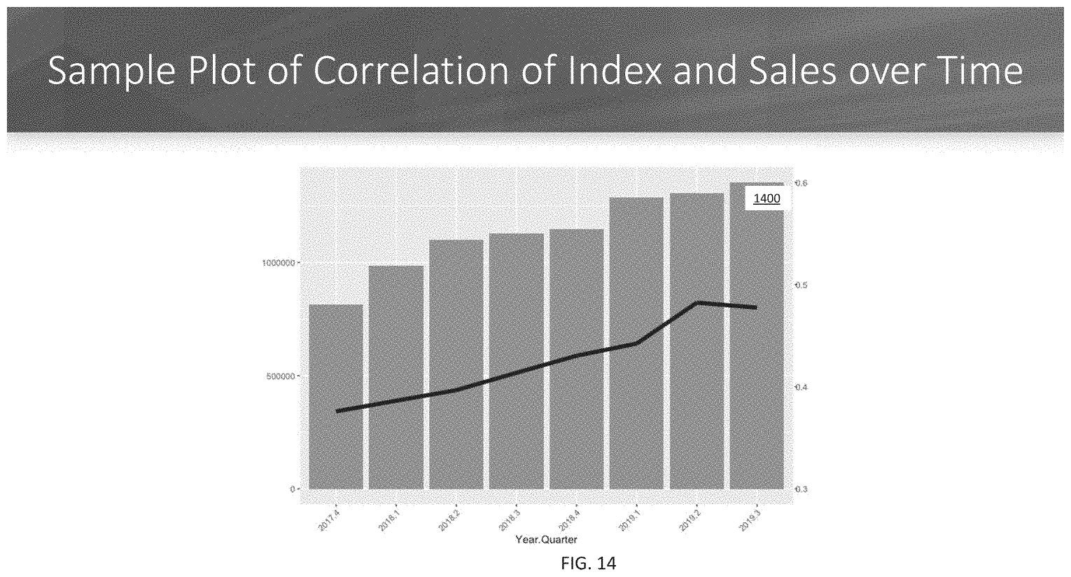

FIG. 14 illustrates a chart 1400 indicating changes in correlation of the index to output over time. The chart indicates that the correlation is more predictive of sales over time, showing an improvement in predictive performance of the effectiveness index.

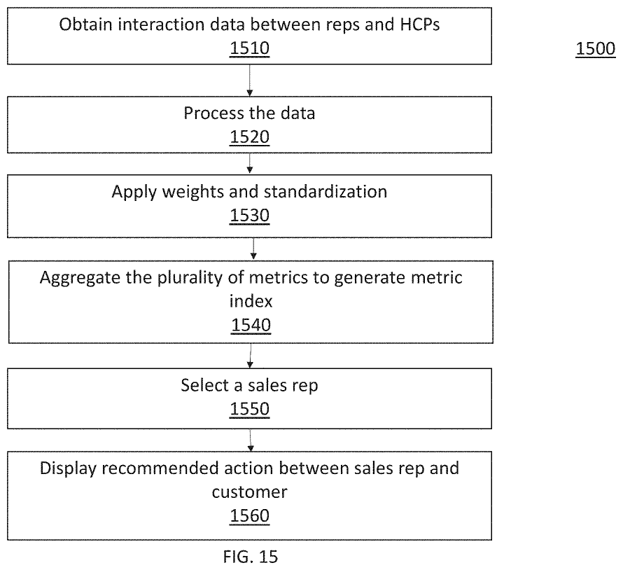

FIG. 15 illustrates a message flow diagram 1500 for generating an effectiveness index compiled by measuring a set of engagement metrics using machine learning. The effectiveness index may indicate the effectiveness of a particular rep in interacting with (e.g., soliciting positive engagement with) an HCP. The effectiveness index may be provided to a decision support engine 120 so that the decision support engine 120 can produce suggestions that are more likely to be followed by reps, successfully implement strategies devised by marketing managers, and increase engagement between reps and HCPs.

In a first operation 1510, the system obtains interaction data between reps and HCPs. The interaction data may include messages sent by reps to HCPs and actions taken or not taken by the HCPs upon receiving the messages. For example, the system may log if HCPs acknowledge, accept, ignore, or decline an action in a message sent by a rep. The system may obtain information about events attended by both reps and HCPs, location tracking data for reps, times of day and frequencies of communication, and communication channels used by both reps and HCPs.

In a second operation 1520, the system processes the interaction data for each sales rep. The system may process the interaction data to determine metrics for the index score. The system may use one or more trained machine learning algorithms to compute metrics based on the data. The components may include adherence to calendar events, location prediction, tendency to engage with suggestions, engagement patterns with HCPs, and effectiveness indices between reps and HCPs.

In a third operation 1530, the system applies weights and standardizations to each of the different metrics. The system may apply weights algorithmically or invite users to manually apply weights. The weights may be applied to target particular types of engagement between reps and HCPs, maximize total engagement between reps and HCPs, maximize engagement between particular reps and particular HCPs, implement particular strategies or tactics devised by marketing managers, increase communication in a particular channel, or with respect to another target outcome.

In a fourth operation 1540, the system aggregates the plurality of metrics. The system may produce the effectiveness index by adding the weighted metrics or may produce the score as a product of the weighted metrics. The system may then provide the effectiveness index to the decision support engine 120, where it may be actionable to produce suggestions for reps.

In a fifth operation 1550, the system selects, based on the index scores of the sales representatives, a sales representative to present a recommended interaction with an HCP. For a particular HCP, the system may provide a ranking of scores between the HCP and different reps. The system may then select the rep with the highest score with the particular HCP. This top score may indicate that the selected rep is most effective at communicating with the HCP.

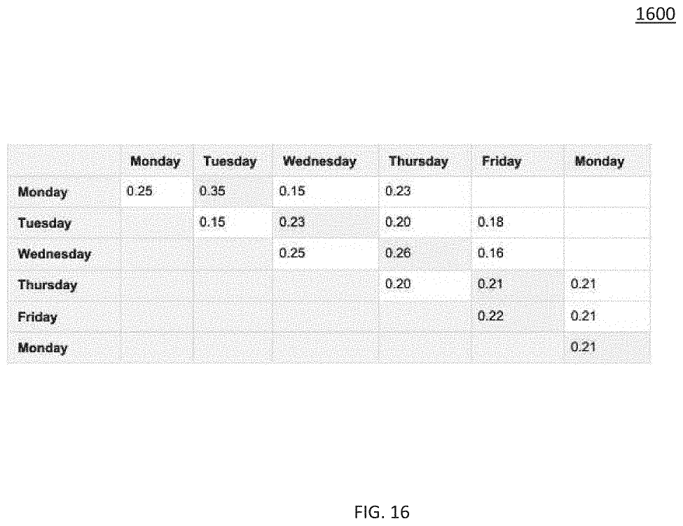

In a sixth operation the system displays, on a graphical user interface of an electronic device of the sales representative, a recommended interaction between the sales representative and the customer. The interaction may include a suggested message for the rep to send to the HCP, reason text explaining why the suggestion was generated, and a suggested method of communication for the rep to send the message to the HCP. FIG. 16 shows an implementation 1600 of the index score 260 being used to predict engagement between a rep and an HCP. The index score 260 may predict engagement at a current or a future time. Future times may include times days, weeks, months, or years in the future. In the illustrative implementation, the index score 260 makes predictions for a current day and a following three days. The numbers may indicate a relative likelihood that an engagement action will occur during each of the days for which predictions are made. The shaded number may indicate the day on which it is most likely an engagement event will occur/

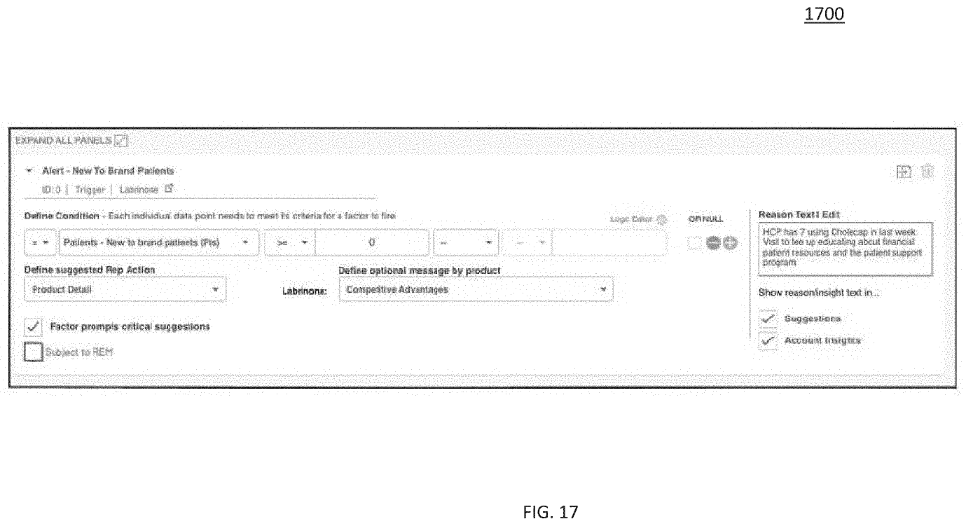

FIG. 17 shows an implementation 1700 of trigger suggestions, which are suggestions that may be provided to reps even if the rep engagement model predicts that the messages are unlikely to be engaged upon. The trigger suggestions may be suggestions that may be part of a brand strategy and are not algorithmically connected to engagement.

In the implementation 1700 of FIG. 17, the decision support engine 120 may manually set a probability threshold for presentation of a trigger suggestion. For example, the probability threshold may be that, if the rep were to take the suggestion, there would be a 70% chance that the HCP would respond. In this way, trigger suggestions may be incorporated in a manner that increases engagement between reps and HCPs. The decision support engine 120 may suppress trigger suggestions that fall below the threshold percentage. A user may be able to view the suggestions that were suppressed.

Filtering trigger suggestions may be implemented using a rules-based interface. In the implementation of FIG. 17, the interface includes a condition stating that if there are 0 or more patients that are new to the brand, to present the critical suggestion. A user may have the option of enabling a factor to prompt presentation of critical suggestions or subject the suggestions to the rep engagement module (REM). Using the latter option compares the probability of engagement from providing the suggestion to the HCP with a threshold probability.

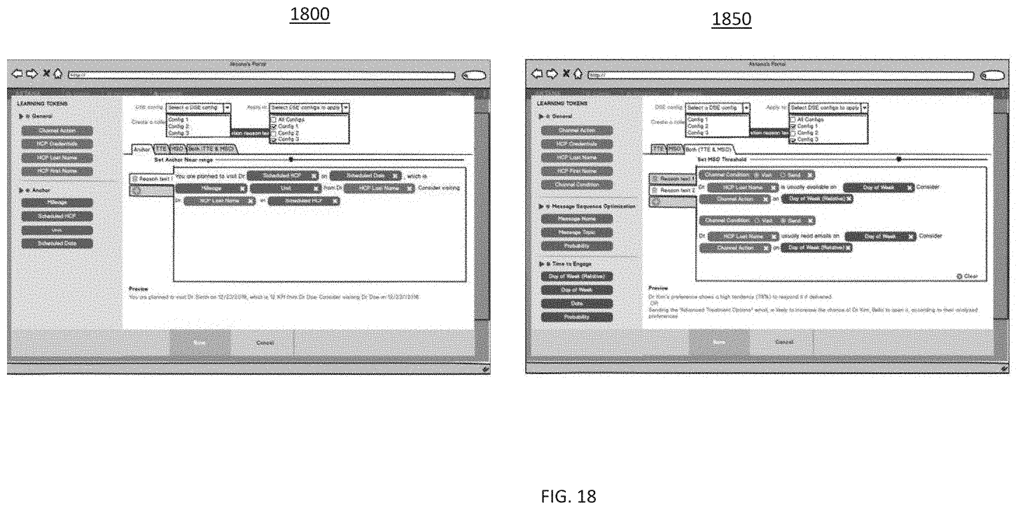

FIG. 18 illustrates methods 1800 and 1850 for generating reason text to send to reps or marketing managers along with suggestion text. Reason text may provide the index score to the rep, to influence the rep to take the provided suggestion, or to the marketing manager to assess whether particular strategies may be effective for particular reps. The index score may be a human-readable value. The index score may be provided as a qualitative word or phrase, indicating a strong relationship between the rep and the HCP the suggestion pertains to. For example, the index score may be represented as a grade, such as “A”, “B”, or “C.” The index score may also be converted into a number that the rep or marketing manager may understand or be trained to understand, such as a number between one and five, or zero and 100. Reason text may annotate the submission to provide reps with information regarding why the submission is being presented to the reps or marketing managers, to persuade them that accepting the submission is worthwhile. The reason text may be semi-static, including both hard-coded language and modifiable tags. The tags may be generated manually or algorithmically. The tokens may point to values for parameters that may have prompted the suggestion to surface. These values may be retrieved when the text is generated to provide the rep or marketing manager with the data needed to understand why the suggestion was presented in the first place. Giving the rep or marketing manager a better understanding of why the suggestion was presented may make it more likely that the rep or marketing manager will follow through on the suggestion. In addition, reason text may personalize the rep's experience, which may itself lead to higher engagement. Providing information which appeals to the rep may make the rep trust the suggestion process more.

Reason text may be artificial intelligence-driven reason text (AIRT) or personalized reason text (PRT). AIRT may provide analytical data to reps to give them hard data to support why suggestions are presented. Examples of analytical data may include outputs for many of the calculated metrics, including index scores and probabilities of engagement from the suggestions. Personalized reason text may appear more personalized to specific reps, in order to appeal to the reps' personalities. Such explanations of suggestions with appeals to personality may be more persuasive than presentations of analytical data.

FIG. 18 illustrates a user interface for a reason text editor. The reason text editor may enable users (e.g., marketing managers) to add reason text manually or use one or more algorithms to generate reason text to present.

The user interface of FIG. 18 includes learning tokens and anchors. The learning tokens are tags that reference data values connected to particular HCPs, such as channel actions, names of HCPs, numbers of miles traveled, schedule information, and other values. The tokens may be organized into categories, such as “general” and “anchor.” Within a dialog window, a user may enter a script for a reason text message and embed tags from one or more different categories. Users may apply different configurations of the DSE to the reason text. The reason text editor may be optimized for different configurations of the decision support engine 120, including message sequence optimization, TTE, and Anchor.

The reason text editor may produce reason text using channel condition tokens, which may modify the presented reason text based on the communication channel between the rep and the HCP.

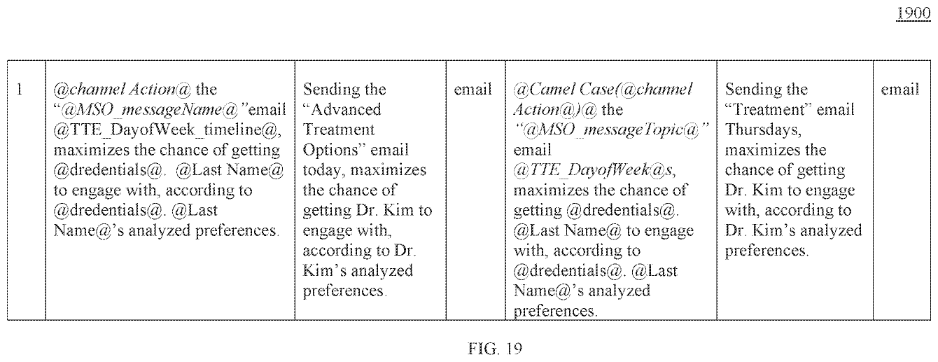

FIG. 19 illustrates examples 1900 of presented reason text. The reason text may be stock text embedded with tags, which retrieve information for presentation from the decision support engine 120.

The engagement prediction system 270 may test the models it implements, such as the machine learning models, on reps using whitelists and blacklists. For example, the system may enable operators, marketing managers, or administrators to whitelist particular reps to receive algorithmically generated suggestions, and blacklist other reps. These users may select reps for the whitelist or blacklist based on their engagement scores with particular HCPs. The presented text in the implementation of FIG. 18 is analytical reason text. The text displays that performing particular actions at particular times maximizes chances of engagement. FIG. 18 shows both the hardcoded text with tags embedded and the text read by the reps, which contains values retrieved when the system reads the tags.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

### Computer Systems

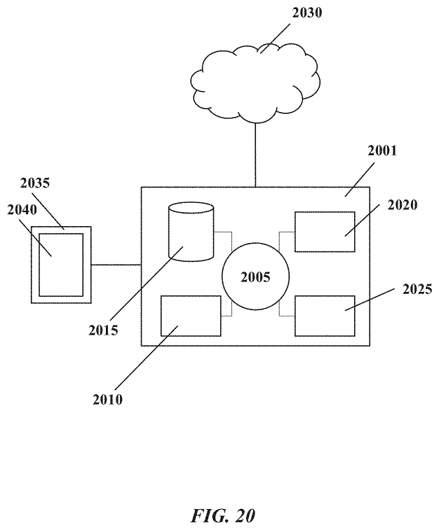

The present disclosure provides computer systems that are programmed to implement methods of the disclosure. FIG. 20 shows a computer system 2001 that is programmed or otherwise configured to calculate the effectiveness index described herein. The computer system 2001 can regulate various aspects of producing suggestions of the present disclosure, such as, for example, performing machine learning analysis. The computer system 2001 can be an electronic device of a user or a computer system that is remotely located with respect to the electronic device. The electronic device can be a mobile electronic device.

The computer system 2001 includes a central processing unit (CPU, also “processor” and “computer processor” herein) 2005, which can be a single core or multi core processor, or a plurality of processors for parallel processing. The computer system 2001 also includes memory or memory location 2010 (e.g., random-access memory, read-only memory, flash memory), electronic storage unit 2015 (e.g., hard disk), communication interface 2020 (e.g., network adapter) for communicating with one or more other systems, and peripheral devices 2025, such as cache, other memory, data storage and/or electronic display adapters. The memory 2010, storage unit 2015, interface 2020 and peripheral devices 2025 are in communication with the CPU 2005 through a communication bus (solid lines), such as a motherboard. The storage unit 2015 can be a data storage unit (or data repository) for storing data. The computer system 2001 can be operatively coupled to a computer network (“network”) 2030 with the aid of the communication interface 2020. The network 2030 can be the Internet, an internet and/or extranet, or an intranet and/or extranet that is in communication with the Internet. The network 2030 in some cases is a telecommunication and/or data network. The network 2030 can include one or more computer servers, which can enable distributed computing, such as cloud computing. The network 2030, in some cases with the aid of the computer system 2001, can implement a peer-to-peer network, which may enable devices coupled to the computer system 2001 to behave as a client or a server.

The CPU 2005 can execute a sequence of machine-readable instructions, which can be embodied in a program or software. The instructions may be stored in a memory location, such as the memory 2010. The instructions can be directed to the CPU 2005, which can subsequently program or otherwise configure the CPU 2005 to implement methods of the present disclosure. Examples of operations performed by the CPU 2005 can include fetch, decode, execute, and writeback.

The CPU 2005 can be part of a circuit, such as an integrated circuit. One or more other components of the system 2001 can be included in the circuit. In some cases, the circuit is an application specific integrated circuit (ASIC).

The storage unit 2015 can store files, such as drivers, libraries and saved programs. The storage unit 2015 can store user data, e.g., user preferences and user programs. The computer system 2001 in some cases can include one or more additional data storage units that are external to the computer system 2001, such as located on a remote server that is in communication with the computer system 2001 through an intranet or the Internet.

The computer system 2001 can communicate with one or more remote computer systems through the network 2030. For instance, the computer system 2001 can communicate with a remote computer system of a user (e.g., a mobile user device). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 2001 via the network 2030.

Methods as described herein can be implemented by way of machine (e.g., computer processor) executable code stored on an electronic storage location of the computer system 2001, such as, for example, on the memory 2010 or electronic storage unit 2015. The machine executable or machine-readable code can be provided in the form of software. During use, the code can be executed by the processor 2005. In some cases, the code can be retrieved from the storage unit 2015 and stored on the memory 2010 for ready access by the processor 2005. In some situations, the electronic storage unit 2015 can be precluded, and machine-executable instructions are stored on memory 2010.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 2001, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 2001 can include or be in communication with an electronic display 2035 that comprises a user interface (UI) 2040 for providing, for example, suggested text to pharma reps. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 2005. The algorithm can, for example, calculate an effectiveness of a rep interacting with an HCP.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A computer-implemented method for generating an index score, the method comprising:
(a) obtaining data associated with a plurality of interactions between (i) a plurality of sales representatives and (ii) a customer;
(b) for each sales representative:
(i) processing the data to determine a plurality of components of the index score;
(ii) applying a plurality of weights and standardizations to the plurality of components to generate a plurality of metrics;
(iii) aggregating the plurality of metrics to generate the index score, wherein the index score is indicative of an effectiveness of the sales representative in interacting with the customer;
(c) selecting, based on the index scores of the plurality of sales representatives, a sales representative of the plurality of sales representatives; and
(d) displaying, on a graphical user interface of an electronic device of the sales representative, a recommended interaction between the sales representative and the customer.

2. The method of claim 1, further comprising: (e) updating the index score as new data is being obtained in (a).

3. The method of claim 2, wherein the index score is updated on a predefined time interval.

4. The method of claim 2, further comprising: (f) displaying the index score as a graphical object in a web portal to the first group, wherein the graphical object is configured to visually change over time as the index score is being updated.

5. The method of claim 1, wherein the plurality of interactions comprises historical and/or on-going interactions between an entity of the first group and an entity of the second group.

6. The method of claim 1, wherein the plurality of interactions occurs over a plurality of channels.

7. The method of claim 6, wherein the plurality of weights are based on a channel type of each of the plurality of channels.

8. The method of claim 7, wherein the plurality of channels comprises one or more of the following: (1) email communications; (2) mobile text messages; (3) social media websites; (4) mobile applications; (5) telephone calls; (6) in-person meetings; (7) video conferencing; (8) conferences or seminars; or (9) events conducted at facilities connected to entities from the second group.

9. The method of claim 8, wherein the plurality of components comprises a rate or a probability of a customer opening one or more email communications sent by an entity from the first group to an entity from the second group.

10. The method of claim 8, wherein the plurality of components comprises a number of completed visits by the entity from the first group and the entity from the second group over a target time period.

11. The method of claim 8, wherein the plurality of components comprises a cadence or frequency of visits by the entity from the first group and the entity from the second group.

12. The method of claim 8, wherein the plurality of components comprises a probability or a rate of the entity from the first group acting on one or more suggestions to visit the entity from the second group.

13. The method of claim 8, wherein the plurality of components comprises a probability or a rate of the entity from the first group acting on one or more suggestions to send email communications to the entity from the second group.

14. The method of claim 13, wherein the one or more suggestions comprises a number of suggestions for the entity from the first group to visit the entity from the second group.

15. The method of claim 13, wherein the one or more suggestions comprises a number of suggestions for the entity from the first group to send the email communications to the entity from the second group.

16. The method of claim 13, wherein the one or more suggestions are automatically generated by a decision support engine (DSE), wherein the DSE is configured to use the index score to generate one or more future suggestions to the entity from the first group for engaging with the entity from the second group.

17. The method of claim 1, wherein the index score is useable as a proxy for estimating sales in an absence of actual historical sales data.

18. The method of claim 1, wherein the one or more products comprises one or more pharmaceutical products, and the customers comprise one or more healthcare providers.

19. A system for generating an index score, the system comprising:
a server in communication with a plurality of data sources; and
a memory storing instructions that, when executed by the server, cause the server to perform operations comprising:
(a) obtaining data associated with a plurality of interactions between (i) a plurality of sales representatives and (ii) a customer;
(b) for each sales representative:
(i) processing the data to determine a plurality of components of the index score;
(ii) applying a plurality of weights and standardizations to the plurality of components to generate a plurality of metrics;
(iii) aggregating the plurality of metrics to generate the index score,
wherein the index score is indicative of an effectiveness of the sales representative in interacting with the customer;
(c) selecting, based on the index scores of the plurality of sales representatives, a sales representative of the plurality of sales representatives; and
(d) displaying, on a graphical user interface of an electronic device of the sales representative, a recommended interaction between the sales representative and the customer.

20. A non-transitory computer-readable storage medium including instructions that, when executed by a server, cause the server to perform operations comprising:
(a) obtaining data associated with a plurality of interactions between (i) a plurality of sales representatives and (ii) a customer;
(b) for each sales representative:
(i) processing the data to determine a plurality of components of the index score;
(ii) applying a plurality of weights and standardizations to the plurality of components to generate a plurality of metrics;
(iii) aggregating the plurality of metrics to generate the index score, wherein the index score is indicative of an effectiveness of the sales representative in interacting with the customer;
(c) selecting, based on the index scores of the plurality of sales representatives, a sales representative of the plurality of sales representatives; and
(d) displaying, on a graphical user interface of an electronic device of the sales representative, a recommended interaction between the sales representative and the customer.
